(19) United States
(12) Patent Application Publication
(10) Pub. No.: US 2008/0166125 A1
(43) Pub. Date: Jul. 10, 2008

(54) Method for Establishing a Subscriber Connection and a System Utilizing the Method

(76) Inventor: Heikki LAAMANEN, Espoo (FI)

Correspondence Address: SALTAMAR INNOVATIONS, 30 FERN LANE, SOUTH PORTLAND, ME, 04106, US

(21) Appl. No.: 12/022,130

(22) Filed: Jan. 29, 2008

Related U.S. Application Data
(63) Continuation of application No. PCT/FI2006/000270, filed on Aug. 4, 2006.

(30) Foreign Application Priority Data
Aug. 5, 2005 (FI) 20050796

(51) Int. Cl. H04J 14/02; H04B 10/12

(52) U.S. Cl. 398/71; 398/116

(57) ABSTRACT

A method and a system for establishing a digital subscriber connection between a central site (1) and a subscriber's transmission device (5). The system comprises an optical fiber (2) between the central site and an intermediate equipment (3) on a signal path between the central site and the subscriber's transmission device, and a metallic pair cable (4) between the intermediate equipment and the subscriber's transmission device. Digital signal processing parts (12a, 12b, 14a, 14b) of a DSL-modem are distributed between the central site and the intermediate equipment. Analog signal processing parts (7) of the DSL-modem are located in the intermediate equipment. The distribution of the digital signal processing parts is selected such that the optical-fiber-carried bit rate is minimal, but on the other hand, the digital signal processing in the equipment is relatively simple.

### RELATED APPLICATIONS

This application claims the right of priority under 35 U.S.C. §120 to PCT application No. PCT/FI2006/000270, filed Aug. 4, 2006, which in turn claims the right of priority under the PCT treaty, to Finnish patent application No. 20050796, filed August 5, 20056. Both the above-identified applications are incorporated herein by reference.

### FIELD OF THE INVENTION

The invention relates to a method and a system for establishing a digital subscriber connection between a central site and a subscriber's transmission device.

Accordingly, aspects of the invention consists of a method of establishing a digital FTTC (Fiber To The Curb, Fiber To The Cabinet) subscriber connection comprising an optical fiber and a metallic pair cable, and to converter equipment connecting the optical fiber and the metallic pair cable, said converter equipment being an integral element of the subscriber connection.

### BACKGROUND OF THE INVENTION

In a conventional subscriber network based on a metallic pair cable, each subscriber is connected to a local telephone exchange or concentrator via the subscriber's metallic pair cable. A typical length of a metallic pair cable may be several kilometers at most. If the pair cable is utilized for transmitting digital information by DSL (Digital Subscriber Line) modem techniques, the transfer characteristics of the cable limit the highest achievable transmission rate from a few hundred kilobits per second to a few megabits per second, depending primarily on the cable length.

Subsequently the term “central site” represents the local telephone exchange or concentrator site.

Subsequently a DSL modem stands for, in a broader sense, a transmission device that converts a digital information stream into an analog signal that can be transmitted over a metallic pair cable by utilizing the available frequency band, and which detects a received signal and converts it into the original digital information stream at the receiving end. A metallic pair cable is a very difficult transmission medium, incurring strong linear amplitude and signal phase distortion, among other impairments. In a DSL modem, these impairments are equalized by using tools offered by digital signal processing, providing the basis for adaptive amplitude and phase distortion correction. A DSL modem may utilize several different modulation methods, e.g. DMT modulation (Discrete MultiTone) or QAM (Quadrature Amplitude Modulation).

In utilizing a conventional subscriber network for transmission of digital information, the signal conversion in the interface of the metallic cable and the digital trunk network is typically carried out by DSLAM equipment (Digital Subscriber Line Access Multiplexer). A DSLAM comprises a number of DSL modems transforming the digital signal into a form suitable for transmission over the metallic pair cable and transmitting the transformed signal in the subscriber direction, and receiving the signal coming from the subscriber as well as converting the signal into digital form. Furthermore, the DSLAM multiplexes traffic from several subscribers and transmits the traffic to the trunk network.

In a digital FTTC subscriber network, data streams for several subscribers are multiplexed onto an optical fiber and transported nearer to the subscribers over the fiber so that the lengths of the metallic pair cables are substantially shorter compared to a conventional subscriber network. As a consequence, the transmission rate of digital information can be increased considerably, because the shorter the cable is, the higher the usable bandwidth. A new problem arises in an FTTC network from the fact that now the DSLAM is to be located nearer to the subscribers, whereas the DSLAM of a conventional network is installed at the central site, where it is much easier to arrange the necessary power supply and where the environmental factors (temperature range and humidity) crucial for the equipment electronics are easier to control. In an FTTC network topology, the remote DSLAM (subsequently RDSLAM) has to be installed, for example, in a cabinet located at a street corner, where it is difficult to arrange a power supply and where the electronics suffer from wide temperature and humidity variations. A substantial portion of the electronics of DSLAM equipment is located in the digital transceivers of the DSL modems and in the circuitry multiplexing the data stream onto the trunk line. Also, a substantial amount of power is consumed for supplying said electronics.

FIG. 1 represents FTTC network topology according to the prior art. An optical fiber 2 connects RDSLAM equipment 3 to equipment 1 at the central site. The RDSLAM comprises each subscriber's entire DSL modem at the optical fiber end, including all analog and digital parts of the DSL modem. Hence, all analog and digital signal processing required for transporting the data over each subscriber's pair cable 4 takes place in the RDSLAM and the subscriber's DSL modem 5. At the central site, the optical fiber is connected to a communication device of the trunk network, such as an ATM (Asynchronous Transfer Mode) switch or an IP (Internet Protocol) router, depending on the transmission protocol used. The data streams between all subscribers and the central site are multiplexed onto the optical fiber 2 in both transmission directions.

In the following, a DSL modem at the subscriber will be termed “subscriber's transmission device”.

Finnish patent publication FI-111,898 discloses a method in which the equipment at the subscriber end of the optical fiber can be made to comprise a minimum of active electronics, comprising only the analog parts of the DSL modem and a multiplexing element adapting the analog-to-digital and digital-to-analog converters included in the analog parts to the optical fiber. FIG. 2 illustrates the principle of the method disclosed in publication FI-111,898, according to which all electronics of the RDSLAM 3 are located in the central site equipment 11, except for the essential analog parts 7 of the DSL modems. This is realized in such a way that the digital sample sequence signals 9a and 9b passed between the digital transceiver 8 in the DSL modem of each subscriber at the central site and the analog-to-digital converter and digital-to-analog converter included in the analog parts 7 of the RDSLAM 3 are transmitted over optical fiber 2. This takes place in such a way that the subscriber-specific digital sample sequence signals 9a and 9b are multiplexed into a single digital information stream in a multiplexer/demultiplexer 10 at the central site and in a multiplexer/demultiplexer 6 of the RDSLAM, and the aggregated information stream is transmitted over the optical fiber 2 in both transmission directions. Furthermore, an auxiliary channel can be provided for each subscriber, via which each digital transceiver 8 of the central site can monitor the operation of the corresponding analog parts 7, for example automatic signal gain control, in the RDSLAM. Said auxiliary channel is realized by multiplexing the data stream in the auxiliary channel onto the information stream transmitted over the optical fiber.

The electronics in the RDSLAM in accordance with the system disclosed in publication FI-111,898 are considerably simpler than those of a conventional RDSLAM, which offers considerable advantages for example in arranging the power supply and in taking account of a demanding installation environment. The drawback of the system disclosed in publication FI-111,898 is that the bit rate of the optical fiber carried information stream is considerably higher than in a conventional RDSLAM. Let us study an example in which data is transmitted to a subscriber in accordance with a bandwidth utilization profile set out in the VDSL standard ITU-T G.993.2 using a frequency range up to 12 MHz. One skilled in the art is aware of the fact that on the basis of the sampling theorem, the sampling frequency of a digital-to-analog conversion (DA conversion) must be at least twice that much, in practice slightly more, approximately 30 MHz, and the required bit accuracy of the DA conversion must be about 12 bits. In such a case, to transmit the DA conversion over the optical fiber, a transmission rate of 30 Mhz×12 bit=360 Mbit/s is required. In the exemplified case, the subscriber bit rate is of the order of 30 Mbit/s at most, and thus approximately a ten-fold bit rate must be transmitted over the optical fiber compared to this. If the traffic of, twenty subscribers, by way of example, is to be transmitted onto a single optical fiber, a transmission rate of about 7.2 Gbit/s is required via the optical fiber. The optical fiber data bit rate is not crucial as such and does not affect the actual fiber costs, but the available technology has a decisive influence on the implementation and costs of the optical transmitter and receiver (fiber transceiver). Available technology offers inexpensive components for implementing the fiber transceiver up to a bit rate of about 1 Gbit/s, but, but when the rate exceeds 1 Gbit/s, the cost of the components increases very steeply. Hence, the very high bit rate required on optical fiber will considerably increase the equipment costs.

It is an object of the present invention to overcome the problems of the prior art and to provide an entirely novel method for implementing an FTTC subscriber network and an RDSLAM.

### SUMMARY

One aspect of the invention relates to a method whereby the digital signal processing of the transmitter and receiver of a DSL modem, required in an RDSLAM at the fiber end of a metallic pair cable and being an essential component in an FTTC subscriber network, which transmits a data signal over a subscriber-specific metallic pair cable, is located in a distributed manner at both ends of the fiber in such a way that part of the digital signal processing takes place at the central site and part of it in the RDSLAM. Thus, the optical fiber transmits the digital signals passed between the signal processing element at the central site and the signal processing element in the RDSLAM in both transmission directions. The divider point delimiting the part of the signal processing to be carried out at the central site is selected in such a way that the fiber bit rate will be sufficiently low, but on the other hand one strives to keep the digital signal processing at the RDSLAM as simple as possible.

As a first aspect of the invention a new method for establishing a digital subscriber connection between a central site and a subscriber's transmission device is provided. The method comprises:
transferring a first signal in digital form through an optical fiber from the central site to an intermediate equipment,
converting in the intermediate equipment the first signal into analog form,
transferring the first signal in analog form through a metallic pair cable from the intermediate equipment to the subscriber's transmission device,
transferring a second signal in analog form through the metallic pair cable from the subscriber's transmission device to the intermediate equipment,
converting in the intermediate equipment the second signal into digital form, and
transferring the second signal in digital form through the optical fiber from the intermediate equipment to the central site;
wherein a digital subscriber line modem (a DSL-modem) is located distributed between the central site and the intermediate equipment; and wherein the method further comprises:
   using a first transmitter part of the DSL-modem in the intermediate equipment for digital signal processing of the first signal,
   using a second transmitter part of the DSL-modem in the central site for digital signal processing of the first signal,
   using a first receiver part of the DSL-modem in the intermediate equipment for digital signal processing of the second signal,
   using a second receiver part of the DSL-modem in the central site for digital signal processing of the second signal, and
   using analog parts of the DSL-modem in the intermediate equipment for analog signal processing of the first signal and for analog signal processing of the second signal.

As a second aspect of the invention a new system for establishing a digital subscriber connection between a central site and a subscriber's transmission device is provided. The system comprises:
an optical fiber between the central site and an intermediate equipment disposed in the data path between the central site and the subscriber transmission device, the central site being capable of transmitting a first signal in digital form to the optical fiber and receiving a second signal in digital form from the optical fiber,
a metallic pair cable between the intermediate equipment and the subscriber's transmission device, the intermediate equipment being capable of receiving the first signal in digital form from the optical fiber, converting the first signal into analog form, transmitting the first signal in analog form to the metallic pair cable, receiving the second signal in analog form from the metallic pair cable, converting the second signal into digital form, and transmitting the second signal in digital form to the optical fiber;
wherein a digital subscriber line modem (a DSL-modem) is located distributed between the central site and the intermediate equipment such that:
   the intermediate equipment includes a first transmitter part of the DSL-modem for digital signal processing of the first signal,
   the central site includes a second transmitter part of the DSL-modem for digital signal processing of the first signal,
   the intermediate equipment includes a first receiver part of the DSL-modem for digital signal processing of the second signal,
   the central site includes a second receiver part of the DSL-modem for digital signal processing of the second signal, and
   the intermediate equipment includes analog parts of the DSL-modem for analog signal processing of the first signal and for analog signal processing of the second signal.

In systems according to preferred embodiments of the invention, the digital signal processing of a DSL modem utilizing Discrete MultiTone modulation is distributed between the central site and the RDSLAM in such a way that the active electronics included in the RDSLAM is simpler and less costly than that of the prior art.

In systems according to preferred embodiments of the invention, the digital signal processing of a DSL modem utilizing QAM modulation is distributed between the central site and the RDSLAM in such a way that the active electronics included in the RDSLAM are simpler and less costly than those of the prior art.

The invention affords substantial advantages.

In FTTC topology, the RDSLAM equipment to be installed in the hard environment at the subscriber end of the optical fiber is less complex, comprises less digital electronic circuits and can be implemented using less expensive optical components as compared to a system of the prior art.

In the following, the invention will be examined in greater detail by reference to the appended drawings and exemplifying embodiments.

### LIST OF FIGURES

FIG. 1 represents the structure of a prior art conventional FTTC subscriber network and the RDSLAM equipment residing at the subscriber end of an optical fiber.

FIG. 2 depicts the structure of a prior art network further developed from the conventional FTTC subscriber network, the RDSLAM equipment residing at the subscriber end of the optical fiber and central site equipment in which the DSL modem included in the conventional RDSLAM is located in a distributed manner so that the analog parts are located in an RDSLAM and the digital signal processing is entirely located at the central site.

FIG. 3 illustrates a principle according to the invention whereby the digital signal processing of a DSL modem, which is located entirely in an RDSLAM of a conventional system, is deployed in a distributed manner in both the RDSLAM and at the central site.

FIG. 4 illustrates signal processing in a prior art Discrete MultiTone transmitter and receiver, to which reference is made in describing preferred embodiments of the invention.

FIG. 5 illustrates signal processing in a prior art QAM transmitted and receiver, to which reference is made in describing preferred embodiments of the invention.

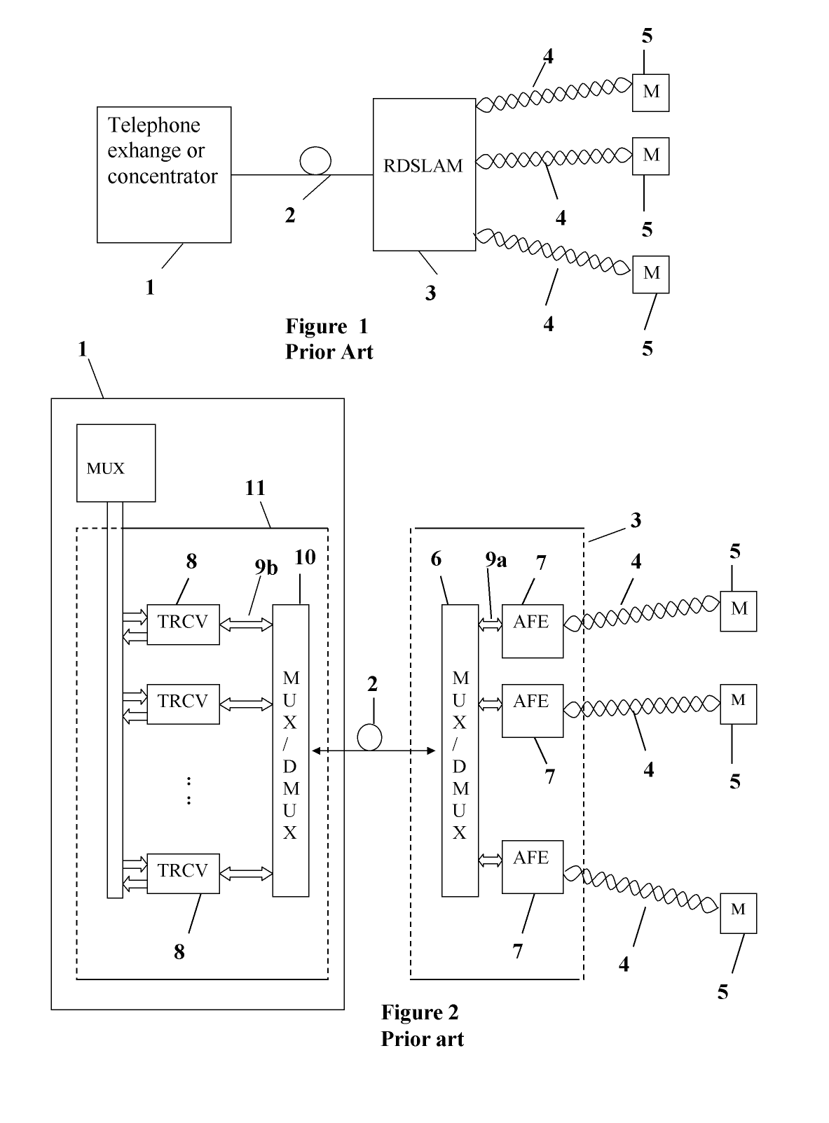

### DETAILED DESCRIPTION

The following abbreviations are used in this document:

AD conversion analog-to-digital conversion

AGC Automatic Gain Control

ATM Asynchronous Transfer Mode

DA conversion Digital-to-Analog conversion

DMT modulation Discrete MultiTone modulation

DSL Digital Subscriber Line

DSLAM Digital Subscriber Line Access Multiplexer

DSP Digital Signal Processing

FTTC Fiber To The Curb, Fiber To The Cabinet; subscriber network consisting of an optical fiber and a metallic cable

IP Internet Protocol

QAM Quadrature Amplitude Modulation

RDSLAM Remote DSLAM of an FTTC network

### Concepts

In prior art methods, digital signal processing functions of the subscriber specific DSL modem reside either entirely in the RDSLAM or entirely at the central site. In its most basic form, the underlying concept of the present invention is to distribute the digital signal processing such that parts of the DSP functions of the receiver are located at the central site, and part of those function are located in the RDSLAM. The digital signals passed between the signal processing functions are transmitted over one or more optical fibers by multiplexing the signals from all subscribers in digital form onto an optical fiber or fibers. The functionality division delineating the part of the signal processing, to be located at the central site, is selected so as to provide minimal transmitted bit rate over the fiber, while striving to keep the digital signal processing at the RDSLAM as simple as possible.

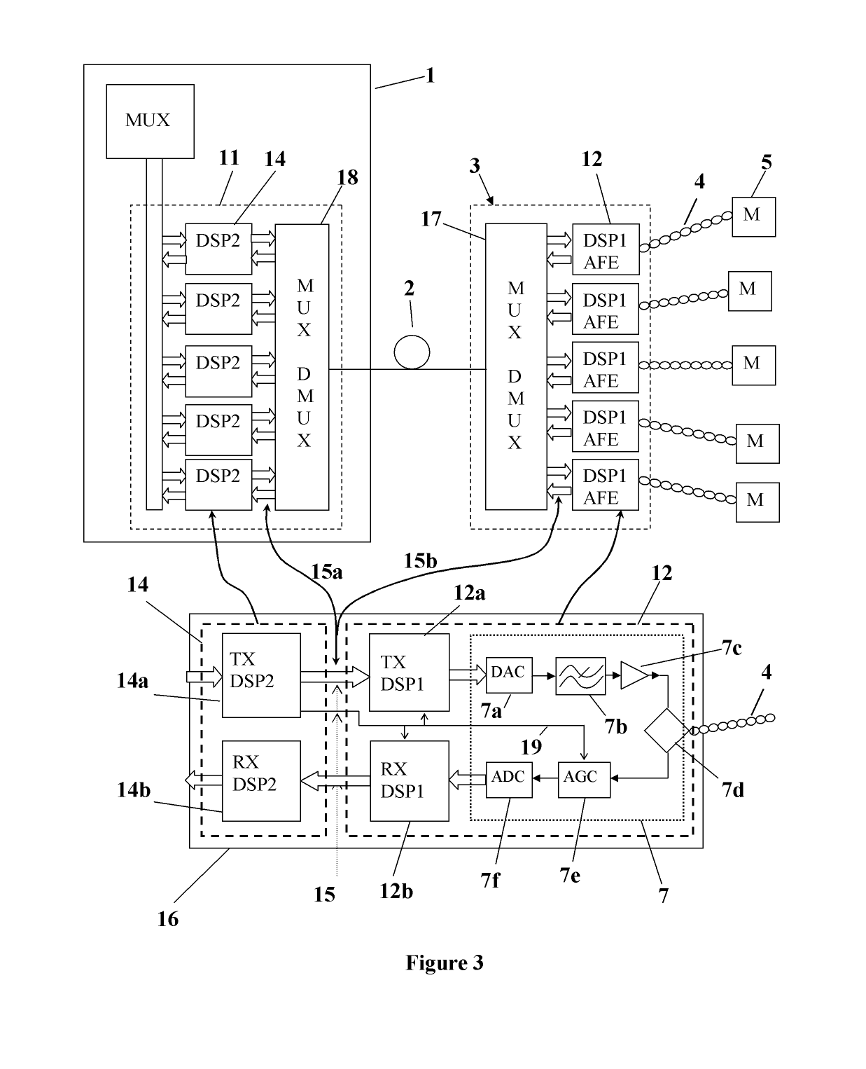

FIG. 3 illustrates preferred details of the system according to the invention. An optical fiber 2 connects the conversion and multiplexing equipment 11 at the central site and the RDSLAM equipment 3, which is closer in the transmission path to the subscribers. A metallic pair cable 4, i.e. a subscriber line, connects each subscriber's transmission device 5 to the RDSLAM. Data is transported in both transmission directions over the metallic pair cable 4 by using a modulation method appropriate for a transmission link constituted by a metallic pair cable, for example the DMT or QAM method. FIG. 3 illustrates how the digital signal processing functions of a subscriber-specific DSL modem 16, which in the method according to the prior art are located entirely in the RDSLAM or entirely at the central site, are distributed according to this aspect of the present invention. A first signal processing element 12 residing in the RDSLAM comprises all analog parts 7 of the DSL modem as well as a first transmitter part 12a and a first receiver part 12b, which perform digital signal processing. The analog parts 7 comprise elements known to those skilled in the art, including a digital-to-analog converter 7a, an analog filter 7b, a line driver 7c, hybrid circuitry 7d, an AGC circuit 7e and an analog-to-digital converter 7f. A second signal processing element 14 located at the central site comprises a second transmitter part 14a and a second receiver part 14b, which perform digital signal processing. Hence, the digital signal processing of the DSL modem is located such that part of the digital signal processing of both the transmitter and the receiver, takes place at the central site, and part of it in the RDSLAM.

The digital signal 15a of the sending direction and the digital signal 15b of the receiving direction, which pass the divider point 15 between the first and second signal processing element (12 and 14) of each subscriber, are multiplexed in a first multiplexing/demultiplexing element 17 residing in the RDSLAM and in a second multiplexing/demultiplexing element 18 residing at the central site. The multiplexed signals are transported over the optical fiber 2 in both transmission directions. Likewise, the subscriber-specific signals 15a and 15b of the sending and receiving direction are demultiplexed and separated at the opposite end of the optical fiber in said first and second multiplexing/demultiplexing element.

The analog parts 7 in the RDSLAM, the first transmitter part 12a and the first receiver part 12b, possibly require control signals from the signal processing elements 14a and 14b of the central site, and also from the processor at the central site, which monitors the operation of said parts. The control signals are generated by control command generator such as the DSP, and transported over the optical fiber 2 via an auxiliary channel, which is realized by multiplexing the control signals 19 with the digital signal 15a of the sending direction onto the optical fiber.

The preference according to which the digital signal processing of both the transmitter and the receiver is divided among the central site and the RDSLAM is greatly dependent on several factors. Those factors include the modulation method employed, how complex signal processing functions one desires to deploy in the RDSLAM, how low a fiber bit rate one desires to achieve, and the like. In the following, a system utilizing Discrete MultiTone modulation and a system utilizing QAM modulation are considered as examples. It should be noted that the examples below represent only two preferred embodiments and it will be apparent to one skilled in the art that the invention is not limited to these examples and to the modulation methods of said examples, but it can be varied in a number of ways within the scope of the inventive idea.

### PREFERRED EMBODIMENTS IN UTILIZING DMT MODULATION IN TRANSMISSION OVER A METALLIC PAIR CABLE

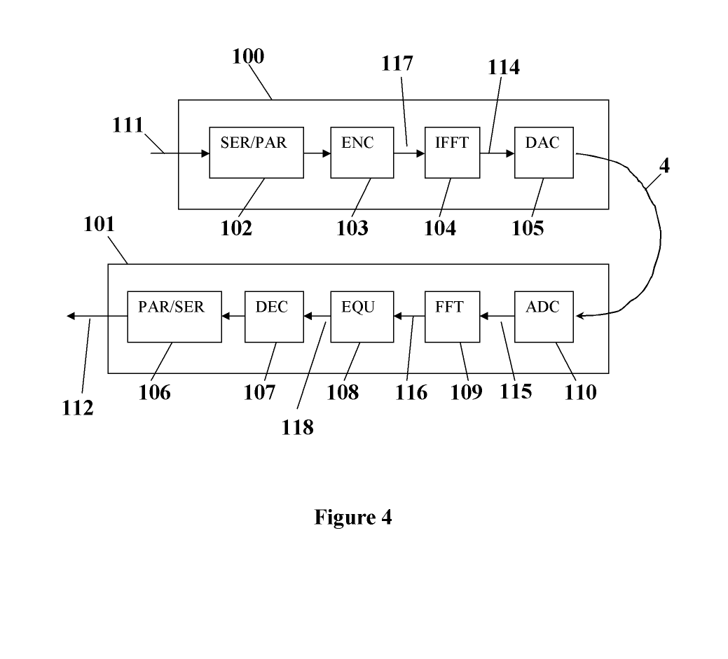

FIG. 4 depicts a transmission system of the prior art utilizing DMT modulation (Discrete MultiTone modulation), which is widely used in ADSL, ADSL+ and VDSL2 modems. The operation of the DMT transmitter 100 and DMT receiver 101 is well known to those skilled in the art (e.g. John A. C. Bingham, Multicarrier Modulation for Data Transmission: An Idea Whose Time Has Come, IEEE Communications Magazine, May 1990), and thus said operations will be only briefly described herein.

A digital data stream 111 to be transmitted over the transmission link, which in this case is a metallic pair cable 4, is grouped in element 102 into bit sets, and each bit set is expressed in a coder element 103 as a complex vector whose magnitude and phase represent the amplitude and phase of the subcarrier corresponding to each bit set. The number of data bits comprised in a discrete bit set is selected in accordance with how many bits the subcarrier corresponding to said bit set one wishes to transport over the link. The coder element 103 thus generates K complex values 117 (“first K set” hereinbelow), as many as the desired number of carriers transporting information. Said K complex values are inserted in a first N-element complex vector and the remaining N-K elements are set to zero. In practice, N is favourably selected to be a power of two.

A first Fourier transformation element 104 performs an inverse discrete Fourier transformation on the first complex vector, and produces a second N-element complex vector. A first N-element real vector 114 is obtained from the real parts of said second N-element complex vector and it represents a discrete time domain signal sample comprising N elements. These N signal samples are converted into analog form in a DA converter 105, and the resultant analog signal form is transmitted after low-pass filtering to a pair cable 4. The analog signal comprises K carriers in the frequency domain, each carrying a certain number of data bits. The signal transported through the pair cable 4 is converted into a discrete time digital sample sequence signal in an AD converter 110 of the receiver 101. N samples are taken from the sample sequence signal, suitably phased to the starting time of the signal form sent by the transmitter, and an N-element second real vector 115 is obtained.

A second Fourier transformation element 109 performs a discrete Fourier transformation on the second real vector, and the result is an N-element third complex vector whose given K elements 116 (“second K set”) comprise the data information passed over cable 4. The signal amplitude and phase distortion incurred in the cable 4 has changed the phase and amplitude of each element in the third complex vector 116. The phase and amplitude are corrected with an adaptive equalizer 108, after which each of the K elements are expressed as a bit set in a detector element 107, and the bit set is further converted into a serial bit stream 112 in a equalizer element 106.

When one strives to reduce the bit rate of the fiber-transported information stream, one can select from among a number of division principles according to which the above digital signal processing functions are divided among both ends of the optical fiber. An advantageous division principle is such that the interface of the coder element 103 and the Fourier transformation element 104 is the divider point in the transmitter, and the interface of the Fourier transformation element 109 and the adaptive corrector 108 is the divider point in the receiver. Thus, first K sets 117 are transported over the optical fiber in the sending direction and second K sets 116 are transported in the receiving direction. Hence only the information corresponding to the carriers used (K) is transported over the optical fiber, and the requisite transmission rate on the optical fiber is lower than that required in transporting the AD and DA conversion signals 115 and 114 over the fiber, since in practice K is always considerably smaller than N. This division principle is also advantageous because the majority of the signal processing functions at the receiver is then located at the central site, where for example power consumption does not pose as great a problem as in the RDSLAM.

Let us examine the advantage gained by means of an example:

The bandwidth of signal to be transported over a subscriber cable is 12 MHz. The sampling frequency of the AD and DA conversion is 30 MHz. One transmission direction utilizes the bandwidth 0.1-3.1 MHz and the other transmission direction the bandwidth 7-12 MHz. Let us examine the latter transmission direction, in which the payload bandwidth is 12-7=5 MHz. Hence, the ratio of the K number of the first K set 117 and the N number of the first N-element real vector 114 may be expressed as

K/N=5 MHz/30 MHz=⅙

Taking into account that the K set consists of complex numbers in which one element comprises a real and an imaginary part, the effective value of the ratio K/N will be ⅓. Therefore, the proposed method allows the optical fiber bit rate to be reduced to approximately one third compared to the prior art. Carrying out a corresponding examination at the receiving end, one finds that similar ratio is obtained for the number K in the second K set 116, and the number N in the N-element second real vector 115. Thus the advantage gained is equally great also in the receiving direction, when received information is transported over the optical fiber from the RDSLAM to the central site.

The advantage gained in the other transmission direction is even greater, since the ratio K/N is even smaller:

(3.1−0.1)/30= 1/10

An example of another advantageous division principle is an arrangement where the adaptive equalizer 108 of the receiver is located in the RDSLAM and the detector element 107 at the central site. In such arrangement, the sample sequence signal 118 passed between the adaptive equalizer 108 and the detector element 107 is transported over the optical fiber. This embodiment affords a lower bit rate on the optical fiber, compared to the previous embodiment, since the bit accuracy of signal 118 need not be as high as that of signal 116. On the other hand, the signal processing in the RDSLAM is more complex than that in the previous embodiment.

### PREFERRED EMBODIMENTS IN UTILIZING QAM MODULATION IN TRANSMISSION OVER A METALLIC PAIR CABLE

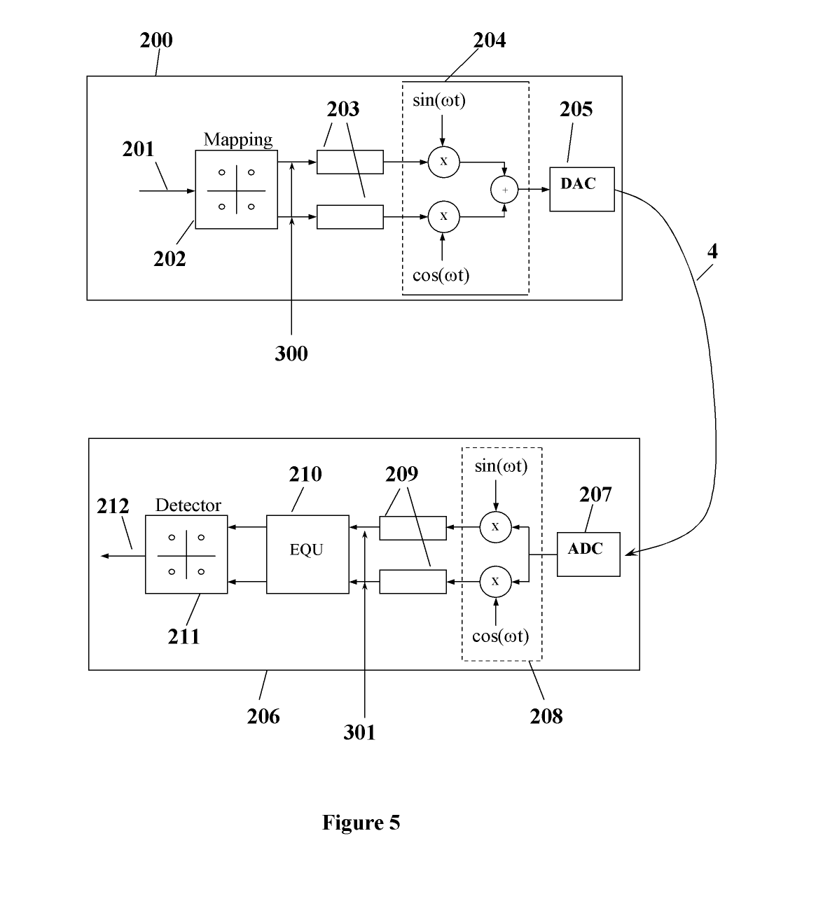

The preferred embodiment of the invention is also greatly dependent on the modulation method to be used on the metallic pair cable. FIG. 5 illustrates a prior art transmission system utilizing QAM modulation (Quadrature Amplitude Modulation). The structural parts of the QAM transmitter 200 and QAM receiver 206 as well as their operation are part of the prior art (for example: John G. Proakis, Digital Communications, McGraw-Hill Book Company), and hence these are only briefly described herein.

A synchronous serial bit stream 201 to be transmitted is divided in transmitter 200 into sets of N bits (N typically 1-10), and each bit set is expressed in symbol converter 202 as a two-dimensional symbol. The digital two-dimensional sample sequence signal 300 constituted by successive symbols, is filtered in baseband filters (aka pulse shapers in many instances) 203, which simultaneously interpolate the two-dimensional signal obtained in such a way that the signal sampling frequency is increased. The obtained signal having sufficient sampling frequency is processed in a modulator 204 that shifts the signal spectrum to be around the desired carrier frequency f (f=(ω/2π) and converts the signal into a one-dimensional real form.

The real signal obtained is converted with a DA converter 205 into analog form, processed with analog filters and analog amplifiers and supplied to a metallic pair cable 4. The signal that has passed the pair cable 4 is converted in receiver 206 into digital sample sequence form. The sample sequence signal obtained is processed in demodulator 208 and in baseband filters 209, together converting the signal into a two-dimensional baseband signal 301. The baseband filters 209 also decimate the signal, and hence the signal sampling frequency is decreased, in practical implementations usually to symbol frequency or double symbol frequency. This baseband signal 301 is distorted owing to linear amplitude and phase distortions incurred in the metallic pair cable. These distortions are corrected with an adaptive equalizer 210. The sample sequence modified by the adaptive equalizer is processed in a detector 211, which outputs a two-dimensional symbol, corresponding to the respective transmitted symbol, from each signal sample, and further converts said symbol into corresponding serial data bits 212.

When one strives to reduce the bit rate of the optical fiber information stream one advantageous division principle for dividing digital signal processing functions among both ends of the optical fiber is the following.

The divider point in the transmitter is selected for example such that the symbol converter 202 is located at the central site and the baseband filters 203 are located in the RDSLAM. Thus the signal 300 passed from the symbol converter to the baseband filters is transported over the optical fiber from the central site to the RDSLAM. This divider point is preferred since the sample frequency of the signal 300 is the symbol frequency, which in practice is considerably lower than the sample frequency of the DA converter.

Another preferable divider point in the sending direction would be obtained for example by dividing the baseband filters 203 into two parts, the first part carrying out the pulse modulation and the second part carrying out the interpolation that increases the signal sample frequency, and by placing the first part into the central site and the second part into the RDSLAM. Such arrangement will simplify the signal processing in the RDSLAM and simultaneously enable a moderate signal bit rate for transfer over the optical fiber.

The divider point in the receiver is selected for example such that the adaptive equalizer 210 is located at the central site and the baseband filters 209 in the RDSLAM. Thus the signal 301 passed from the baseband filters to the corrector is transported over the optical fiber from the RDSLAM to the central site. The sample frequency of signal 301 is preferably the symbol frequency or double symbol frequency, i.e. considerably lower than the sample frequency of the AD conversion, which will considerably decrease the bit rate of the optical fiber carried information in comparison with the prior art. Since the adaptive equalizer 210 is a complex element requiring a considerable amount of signal processing computation, a significant portion of the signal processing is still located at the central site.

Even though the invention has been explained in the above with reference to examples in accordance with the accompanying drawings, it is apparent to one skilled in the art that the invention is not limited to the examples but can be varied in multiple ways within the scope of the inventive idea set forth in the above and in the appended claims. For example, the invention can be applied to all digital modulation methods suited to subscriber cable transmission, and in the embodiments of the invention the optical fiber transmission can be arranged and the subscriber-specific signals that are transported over the optical fiber can be multiplexed onto the optical fiber in many different ways.

What is claimed is:

1. A method for establishing a digital subscriber connection between a central site and a subscriber's transmission device, the method comprising:
transferring a first signal in digital form through an optical fiber from the central site to an intermediate equipment,
converting in the intermediate equipment the first signal into analog form,
transferring the first signal in analog form through a metallic pair cable from the intermediate equipment to the subscriber's transmission device,
transferring a second signal in analog form through the metallic pair cable from the subscriber's transmission device to the intermediate equipment,
converting in the intermediate equipment the second signal into digital form, and
transferring the second signal in digital form through the optical fiber from the intermediate equipment to the central site;
wherein a DSL (Digital Subscriber Line)-modem is distributed between the central site and the intermediate equipment; and wherein the method further comprises:
using a first transmitter part of the DSL-modem in the intermediate equipment for digital signal processing of the first signal,
using a second transmitter part of the DSL-modem in the central site for digital signal processing of the first signal,
using a first receiver part of the DSL-modem in the intermediate equipment for digital signal processing of the second signal,
using a second receiver part of the DSL-modem in the central site for digital signal processing of the second signal, and
using analog parts of the DSL-modem in the intermediate equipment for analog signal processing of the first signal and for analog signal processing of the second signal.

2. A method as claimed in claim 1, wherein control commands for controlling the analog parts of the DSL-modem are specified at the central site and the control commands are transmitted over the optical fiber multiplexed into the first signal.

3. A method as claimed in claim 1, wherein control commands for controlling the first transmitter part of said DSL-modem and for controlling the first receiver part of the DSL-modem are specified at the central site and the control commands are transmitted over the optical fiber multiplexed into said first signal.

4. A system for establishing a digital subscriber connection between a central site and a subscriber's transmission device, the system comprising:
an optical fiber between the central site and an intermediate equipment, the central site being capable of transmitting a first signal in digital form to the optical fiber and receiving a second signal in digital form from the optical fiber,
a metallic pair cable between the intermediate equipment and the subscriber's transmission device, the intermediate equipment being capable of receiving the first signal in digital form from the optical fiber, converting the first signal into analog form, transmitting the first signal in analog form to the metallic pair cable, receiving the second signal in analog form from the pair cable, converting the second signal into digital form, and transmitting the second signal in digital form to the optical fiber;
wherein a digital DSL (Digital Subscriber Line)-modem, is located distributed between the central site and the intermediate equipment such that:
the intermediate equipment includes a first transmitter part of the DSL-modem for digital signal processing of the first signal,
the central site includes a second transmitter part of the DSL-modem for digital signal processing of the first signal,
the intermediate equipment includes a first receiver part of the DSL-modem for digital signal processing of the second signal,
the central site includes a second receiver part of the DSL-modem for digital signal processing of the second signal, and
the intermediate equipment includes analog parts of the DSL-modem for analog signal processing of the first signal and for analog signal processing of the second signal.

5. A system as claimed in claim 4, wherein the central site comprises a control commands generator for controlling the analog parts of the DSL-modem, and a control commands transmitter for transmitting the control commands over the optical fiber multiplexed into the first signal.

6. A system as claimed in claim 5, wherein said command generator is a processor, operating under program control.

7. A system as claimed in claim 4, wherein the central site comprises a control commands generator for controlling the first transmitter part of the DSL-modem and for controlling the first receiver part of said the DSL-modem, and a control commands transmitter for transmitting the control commands over the optical fiber multiplexed into the first signal.

8. A system as claimed in claim 7, wherein said command generator is a processor, operating under program control.
